(19) United States
(12) Patent Application Publication
(10) Pub. No.: US 2026/0004489 A1
(43) Pub. Date: Jan. 1, 2026

(54) METHODS, APPARATUSES AND COMPUTER PROGRAM PRODUCTS FOR PROVIDING TUNING-FREE PERSONALIZED IMAGE GENERATION

(71) Applicant: Meta Platforms, Inc., Menlo Park, CA (US)

(72) Inventors: Zecheng He, Foster City, CA (US); Bo Sun, Menlo Park, CA (US); Juefei Xu, Jersey City, NJ (US); Animesh Sinha, San Francisco, CA (US); Roshan Rajesh Sumbaly, Sunnyvale, CA (US); Ning Zhang, Menlo Park, CA (US); Peizhao Zhang, Los Altos, CA (US); Ankit Rajesh Ramchandani, Menlo Park, CA (US); Peter Vajda, Menlo Park, CA (US); Vincent Charles Cheung, Menlo Park, CA (US); Haoyu Ma, Irvine, CA (US)

(21) Appl. No.: 19/213,377

(22) Filed: May 20, 2025

Related U.S. Application Data
(60) Provisional application No. 63/665,956, filed on Jun. 28, 2024.

(51) Int. Cl. G06T 11/60; G06F 40/40; G06V 10/26; G06V 10/774; G06V 40/16

(52) U.S. Cl. CPC G06T 11/60; G06F 40/40; G06V 10/26; G06V 10/774; G06V 40/161

(57) ABSTRACT

A system and method to generate a target image from a reference image are provided. The system may receive, via a LDM, a reference image and a text prompt. The system may extract, via a trained vision encoder in the LDM, a vision control signal from an object in the reference image. The vision control signal indicates an identity of the object. The system may extract, via trained text encoders in the LDM, text control signals associated with the text prompt. The system may generate, via cross attention summation of an output of a vision cross attention unit(s) associated with the vision control signal and an output of text cross attention units associated with the text control signals, spatial features indicative of the reference image and the text prompt. The system may output, via a decoder in communication with the LDM, a target image based on the generated spatial features.

### CROSS-REFERENCE TO RELATED APPLICATIONS

This application claims priority to U.S. Provisional Application No. 63/665,956, filed Jun. 28, 2024, entitled, “Tuning-Free Personalized Image Generation,” the contents of which is incorporated by reference herein in its entirety.

### TECHNOLOGICAL FIELD

Examples of the present disclosure relate generally to methods, systems, and computer program products for image generation.

### BACKGROUND

Text-to-image models include advanced artificial intelligence (AI) systems designed to generate visual content from textual descriptions. The field of text-to-image generation has seen significant advancements with the introduction of deep learning techniques. Latent diffusion models (LDMs) have emerged as a powerful tool for generating high-quality images from textual descriptions, enabling a wide range of applications in digital art, design, and entertainment. These models leverage the capabilities of neural networks to understand and manipulate visual and textual data, creating images that closely align with given text prompts.

However, maintaining the identity of subjects in reference images while incorporating textual prompts remains a challenge. In addition, as personalization models become more specific to a corresponding identity, the model may have difficulties generalizing to new identities in subsequent images.

### BRIEF SUMMARY

The subject technology is directed to an architecture for generating diverse images from a reference image and is accessible to all users without necessitating individualized adjustments. The technology strikes a balance between preserving the identity of a subject, following complex text prompts and maintaining visual quality.

One aspect of the subject technology is directed to a method for generating a target image from a reference image. The method may include receiving, via a latent diffusion model (LDM), a reference image and a text prompt. The method may also extracting, via a trained vision encoder associated with the LDM, a vision control signal from an object in the reference image, wherein the vision control signal indicates an identity of the subject. The method may also include extracting, via one or more trained text encoders associated with the LDM, one or more text control signals associated with the text prompt. The method may further include generating, via cross attention summation of an output of one or more vision cross attention units associated with the vision control signal and an output of one or more text cross attention units associated with the one or more text control signals, first spatial features indicative of the reference image and text prompt. The method may further include outputting a target image based on the generated spatial features. In some examples, the output of the target image may be via a decoder in communication with the LDM.

Another aspect of the subject technology is directed to outputting a synthetic image associated with a source image. The method may include receiving, at a LDM, a source image including an object associated with an identity. The method may also include extracting, via a first trained machine learning (ML) model associated with the LDM, a first caption indicative of the object in the source image. The method may also include receiving, via a second trained ML model of the LDM, the first caption. The method may further include outputting, via the second ML, a second caption including an enhancement of the first caption. The method may further include receiving, via a text-to-image generation (T2IG) unit of the LDM, the second caption. The method may further include generating, via the T2IG unit based on the second caption, an intermediary image including a trait associated with the object in the source image. The method may also include processing the intermediary image based upon the identity of the object in the source image. The method may further include outputting a synthetic image based on the processed intermediary image. In some examples, a face swap unit may process the intermediary image based upon the identity of the object in the source image.

Yet another exemplary aspect of the subject technology is directed to an apparatus to generate a target image from a reference image. The apparatus may include one or more processors and a memory including computer program code instructions. The memory and computer program code instructions are configured to, with at least one of the processors, cause the apparatus to at least perform operations including receiving, via a LDM, a reference image and a text prompt. The memory and computer program code are also configured to, with the processor(s), cause the apparatus to extract, via a trained vision encoder associated with the LDM, a vision control signal based on an object in the reference image. The vision control signal may indicate an identity of the object. The memory and computer program code are also configured to, with the processor(s), cause the apparatus to extract, via one or more trained text encoders associated with the LDM, one or more text control signals associated with the text prompt. The text prompt may be associated with the reference image. The memory and computer program code are also configured to, with the processor(s), cause the apparatus to generate, via cross attention summation of (i) an output of one or more vision cross attention units associated with the vision control signal and (ii) an output of one or more text cross attention units associated with the one or more text control signals, first spatial features indicative of the reference image and the text prompt. The memory and computer program code are also configured to, with the processor(s), cause the apparatus to output a target image based upon the generated first spatial features.

Additional advantages will be set forth in part in the description that follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, examples of the disclosed subject matter are shown in the drawings; however, the disclosed subject matter is not limited to the specific methods, compositions, and devices disclosed. In addition, the drawings are not necessarily drawn to scale. In the drawings:

FIG. 1 illustrates a diagram of an exemplary network environment in accordance with one or more example aspects of the subject technology.

FIG. 2 illustrates a diagram of an exemplary communication device in accordance with one or more example aspects of the subject technology.

FIG. 3 illustrates an exemplary computing system in accordance with one or more example aspects of the subject technology.

FIG. 4 illustrates a machine learning and training model framework in accordance with example aspects of the present disclosure.

FIG. 5 illustrates a system for generating a pair of images as training data in accordance with one or more example aspects of the subject technology.

FIG. 6A illustrates a system for multistate fine-tuning of training data in accordance with one or more example aspects of the subject technology.

FIG. 6B illustrates a graph describing characteristics of the multistage fine-tuning technique in accordance with one or more example aspects the subject technology.

FIG. 7 illustrates a diffusion model architecture for decoding a target image from a reference image in accordance with one or more example aspects of the subject technology.

FIG. 8 illustrates an example flowchart illustrating operations for generating a target image from a reference image in accordance with an example of the present disclosure.

FIG. 9 illustrates another example flowchart illustrating operations for generating a target image from a reference image in accordance with an example of the present disclosure.

The figures depict various examples for purposes of illustration only. One skilled in the art will readily recognize from the following discussion that alternative examples of the structures and methods illustrated herein may be employed without departing from the principles described herein.

### DETAILED DESCRIPTION

Some examples of the subject technology will now be described more fully hereinafter with reference to the accompanying drawings, in which some, but not all examples of the subject technology are shown. Indeed, various examples of the subject technology may be embodied in many different forms and should not be construed as limited to the examples set forth herein. Like reference numerals refer to like elements throughout.

As used herein, the terms “data,” “content,” “information,” and similar terms may be used interchangeably to refer to data capable of being transmitted, received and/or stored in accordance with examples of the disclosure. Moreover, the term “exemplary,” as used herein, is not provided to convey any qualitative assessment, but instead merely to convey an illustration of an example. Thus, use of any such terms should not be taken to limit the spirit and scope of examples of the disclosure.

As defined herein, a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, an “application” may refer to a computer software package that may perform specific functions for users and/or, in some cases, for another application(s). An application(s) may utilize an operating system (OS) and other supporting programs to function. In some examples, an application(s) may request one or more services from, and communicate with, other entities via an application programming interface (API).

As referred to herein, a Metaverse may denote an immersive virtual space or world in which devices may be utilized in a network in which there may, but need not, be one or more social connections among users in the network or with an environment in the virtual space or world. A Metaverse or Metaverse network may be associated with three-dimensional (3D) virtual worlds, online games (e.g., video games), one or more content items such as, for example, images, videos, non-fungible tokens (NFTs) and in which the content items may, for example, be purchased with digital currencies (e.g., cryptocurrencies) and other suitable currencies. In some examples, a Metaverse or Metaverse network may enable the generation and provision of immersive virtual spaces in which remote users may socialize, collaborate, learn, shop and/or engage in various other activities within the virtual spaces, including through the use of augmented/virtual/mixed reality.

As referred to herein, a resource(s), or an external resource(s) may refer to any entity or source that may be accessed by a program or system that may be running, executed or implemented on a communication device and/or a network. Some examples of resources may include, but are not limited to, HyperText Markup Language (HTML) pages, web pages, images, videos, scripts, stylesheets, other types of files (e.g., multimedia files) that may be accessible via a network (e.g., the Internet) as well as other files that may be locally stored and/or accessed by communication devices.

As referred to herein, a subject(s) may be a person(s), object(s), entity, landscape(s), building, or other point(s) of interest(s) of an image, photograph (photo), picture, or the like. In some examples, the term subject(s) may be utilized interchangeably with object(s).

It is to be understood that the methods and systems described herein are not limited to specific methods, specific components, or to particular implementations. It is also to be understood that the terminology used herein is for the purpose of describing particular embodiments only and is not intended to be limiting.

### Exemplary System Architecture

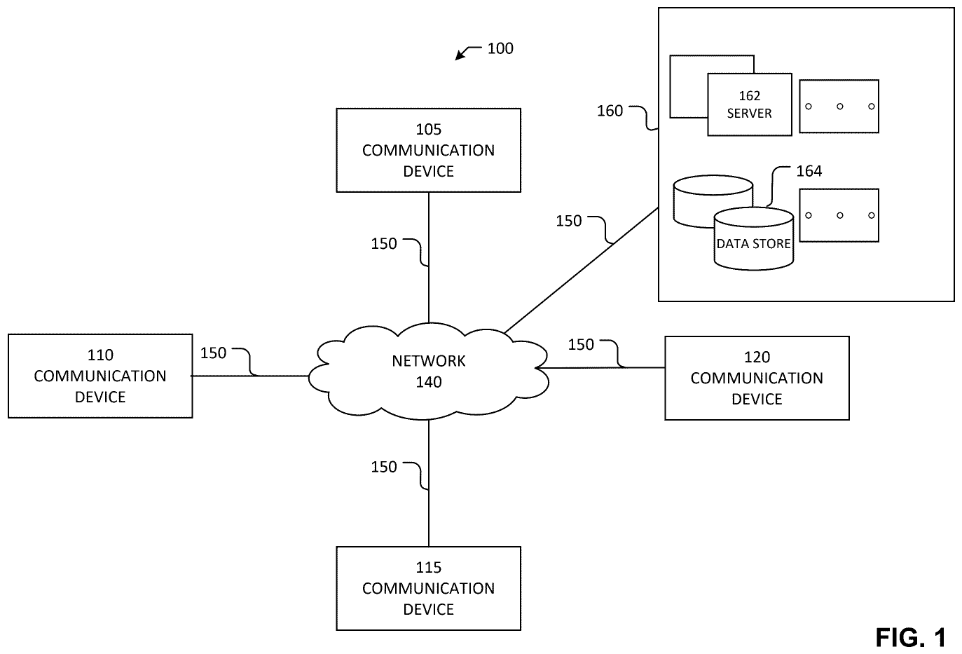

Reference is now made to FIG. 1, which is a block diagram of a system according to exemplary embodiments. As shown in FIG. 1, the system 100 may include one or more communication devices 105, 110, 115 and 120 and a network device 160. Additionally, the system 100 may include any suitable network such as, for example, network 140. In some examples, the network 140. In other examples, the network 140 may be any suitable network capable of provisioning content and/or facilitating communications among entities within, or associated with the network 140. As an example and not by way of limitation, one or more portions of network 140 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 140 may include one or more networks 140.

Links 150 may connect the communication devices 105, 110, 115 and 120 to network 140, network device 160 and/or to each other. This disclosure contemplates any suitable links 150. In some exemplary embodiments, one or more links 150 may include one or more wired and/or wireless links, such as, for example, Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH). In some exemplary embodiments, one or more links 150 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout system 100. One or more first links 150 may differ in one or more respects from one or more second links 150.

In some exemplary embodiments, communication devices 105, 110, 115, 120 may be electronic devices including hardware, software, or embedded logic components or a combination of two or more such components and capable of carrying out the appropriate functionalities implemented or supported by the communication devices 105, 110, 115, 120. As an example, and not by way of limitation, the communication devices 105, 110, 115, 120 may be a computer system such as, for example, a desktop computer, notebook or laptop computer, netbook, a tablet computer (e.g., a smart tablet), e-book reader, Global Positioning System (GPS) device, camera, personal digital assistant (PDA), handheld electronic device, cellular telephone, smartphone, smart glasses, augmented/virtual reality device, smart watches, charging case, or any other suitable electronic device, or any suitable combination thereof. The communication devices 105, 110, 115, 120 may enable one or more users to access network 140. The communication devices 105, 110, 115, 120 may enable a user(s) to communicate with other users at other communication devices 105, 110, 115, 120.

Network device 160 may be accessed by the other components of system 100 either directly or via network 140. As an example and not by way of limitation, communication devices 105, 110, 115, 120 may access network device 160 using a web browser or a native application associated with network device 160 (e.g., a mobile social-networking application, a messaging application, another suitable application, or any combination thereof) either directly or via network 140. In particular exemplary embodiments, network device 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular exemplary embodiments, each server 162 may include hardware, software, or embedded logic components or a combination of two or more such components for carrying out the appropriate functionalities implemented and/or supported by server 162. In particular exemplary embodiments, network device 160 may include one or more data stores 164. Data stores 164 may be used to store various types of information. In particular exemplary embodiments, the information stored in data stores 164 may be organized according to specific data structures. In particular exemplary embodiments, each data store 164 may be a relational, columnar, correlation, or other suitable database. Although this disclosure describes or illustrates particular types of databases, this disclosure contemplates any suitable types of databases. Particular exemplary embodiments may provide interfaces that enable communication devices 105, 110, 115, 120 and/or another system (e.g., a third-party system) to manage, retrieve, modify, add, or delete, the information stored in data store 164.

Network device 160 may provide users of the system 100 the ability to communicate and interact with other users. In particular exemplary embodiments, network device 160 may provide users with the ability to take actions on various types of items or objects, supported by network device 160. In particular exemplary embodiments, network device 160 may be capable of linking a variety of entities. As an example and not by way of limitation, network device 160 may enable users to interact with each other as well as receive content from other systems (e.g., third-party systems) or other entities, or allow users to interact with these entities through an application programming interfaces (API) or other communication channels.

It should be pointed out that although FIG. 1 shows one network device 160 and four communication devices 105, 110, 115 and 120, any suitable number of network devices 160 and communication devices 105, 110, 115 and 120 may be part of the system of FIG. 1 without departing from the spirit and scope of the present disclosure.

### Exemplary Communication Device

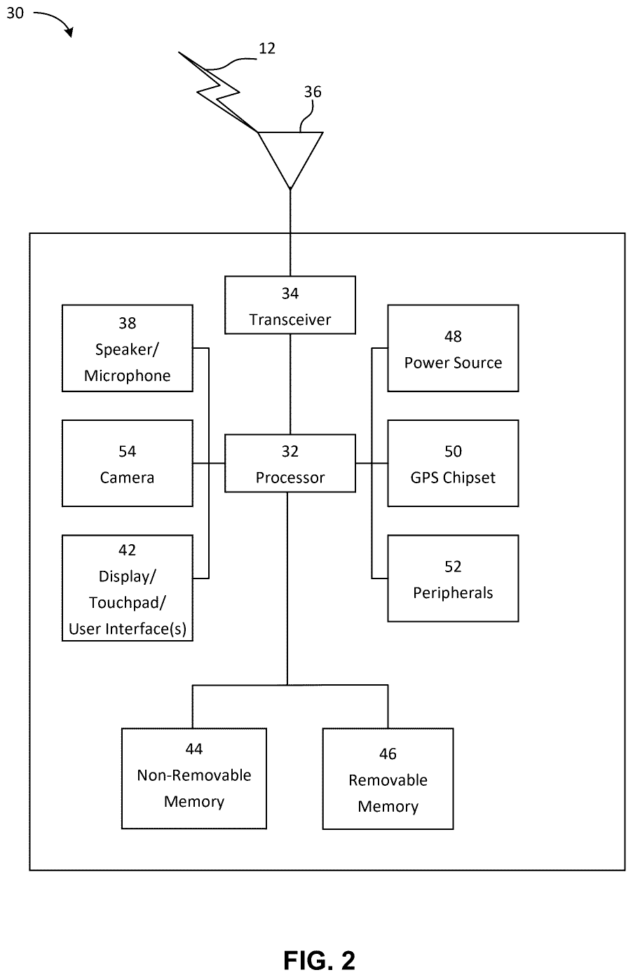

FIG. 2 illustrates a block diagram of an exemplary hardware/software architecture of a communication device such as, for example, user equipment (UE) 30. In some exemplary respects, the UE 30 may be any of communication devices 105, 110, 115, 120. In some exemplary aspects, the UE 30 may be a computer system such as, for example, a desktop computer, notebook or laptop computer, netbook, a tablet computer (e.g., a smart tablet), e-book reader, GPS device, camera, personal digital assistant, handheld electronic device, cellular telephone, smartphone, smart glasses, augmented/virtual reality device, smart watch, charging case, or any other suitable electronic device. As shown in FIG. 2, the UE 30 (also referred to herein as node 30) may include a processor 32, non-removable memory 44, removable memory 46, a speaker/microphone 38, a display, touchpad, and/or user interface(s) 42, a power source 48, a GPS chipset 50, and other peripherals 52. In some exemplary aspects, the display, touchpad, and/or user interface(s) 42 may be referred to herein as display/touchpad/user interface(s) 42. The display/touchpad/user interface(s) 42 may include a user interface capable of presenting one or more content items and/or capturing input of one or more user interactions/actions associated with the user interface. The power source 48 may be capable of receiving electric power for supplying electric power to the UE 30. For example, the power source 48 may include an alternating current to direct current (AC-to-DC) converter allowing the power source 48 to be connected/plugged to an AC electrical receptacle and/or Universal Serial Bus (USB) port for receiving electric power. The UE 30 may also include a camera 54. In an exemplary embodiment, the camera 54 may be a smart camera configured to sense images/video appearing within one or more bounding boxes. The UE 30 may also include communication circuitry, such as a transceiver 34 and a transmit/receive element 36. It will be appreciated the UE 30 may include any sub-combination of the foregoing elements while remaining consistent with an embodiment.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., non-removable memory 44 and/or removable memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example. The non-removable memory 44 and/or the removable memory 46 may be computer-readable storage mediums. For example, the non-removable memory 44 may include a non-transitory computer-readable storage medium and a transitory computer-readable storage medium.

The processor 32 is coupled to its communication circuitry (e.g., transceiver 34 and transmit/receive element 36). The processor 32, through the execution of computer-executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an exemplary embodiment, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another exemplary embodiment, the transmit/receive clement 36 may be configured to transmit and/or receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, (e.g., non-removable memory 44 and/or removable memory 46) as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other exemplary embodiments, the processor 32 may access information from, and store data in, memory that is not physically located on the node 30, such as on a server or a home computer.

The processor 32 may receive power from the power source 48 and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an exemplary embodiment.

### Exemplary Computing System

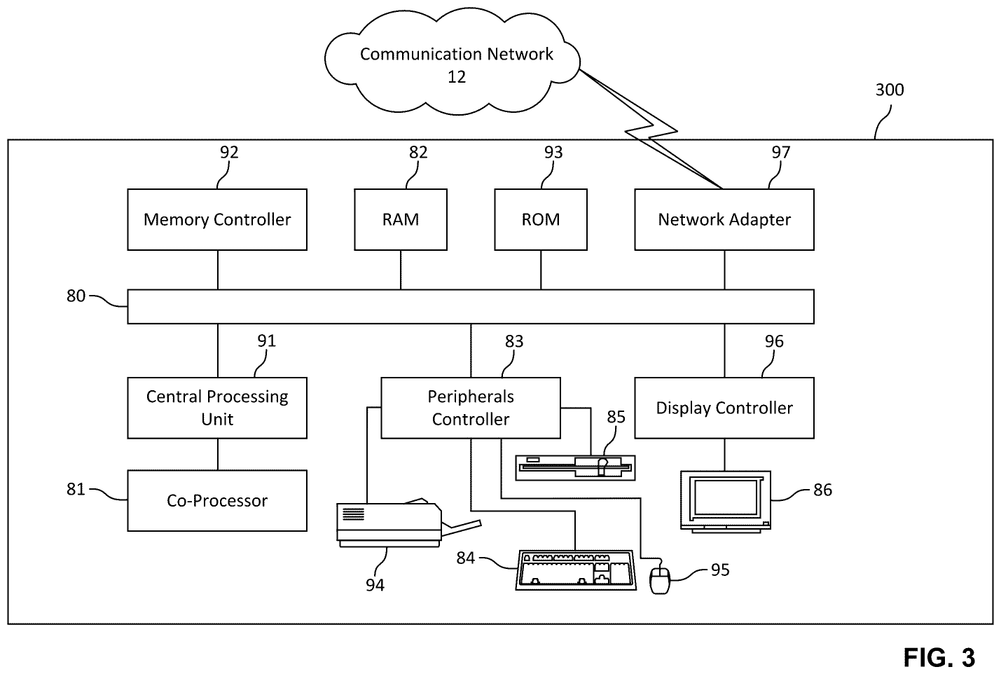

FIG. 3 is a block diagram of an exemplary computing system 300. In some exemplary embodiments, the network device 160 may be a computing system 300. The computing system 300 may comprise a computer or server and may be controlled primarily by computer-readable instructions, which may be in the form of software, wherever, or by whatever means such software is stored or accessed. Such computer-readable instructions may be executed within a processor, such as central processing unit (CPU) 91, to cause computing system 300 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 300 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 300 may contain peripherals controller 83 responsible for communicating instructions from CPU 91 to peripherals, such as printer 94, keyboard 84, mouse 95, and disk drive 85.

Display 86, which is controlled by display controller 96, may be used to display visual output generated by computing system 300. Such visual output may include text, graphics, animated graphics, and video. The display 86 may also include or be associated with a user interface. The user interface may be capable of presenting one or more content items and/or capturing input of one or more user interactions associated with the user interface. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 300 may contain communication circuitry, such as for example a network adapter 97, that may be used to connect computing system 300 to an external communications network, such as network 12 of FIG. 2, to enable the computing system 300 to communicate with other nodes (e.g., UE 30) of the network.

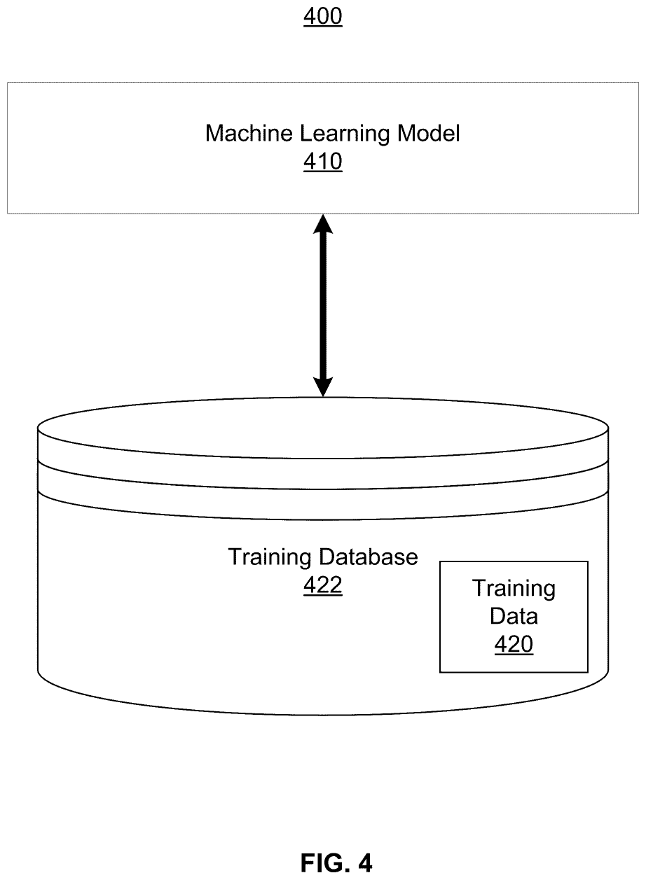

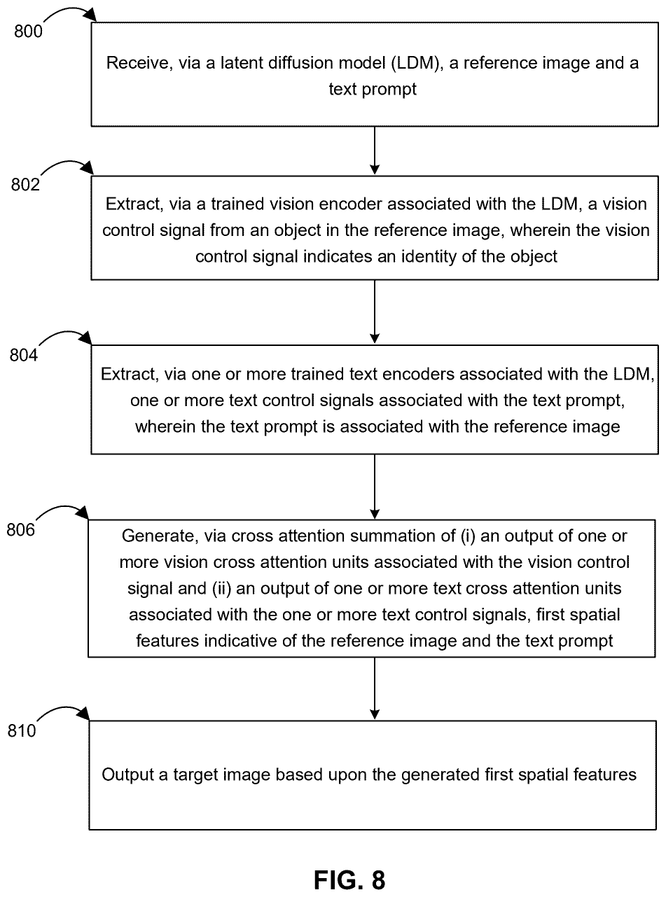

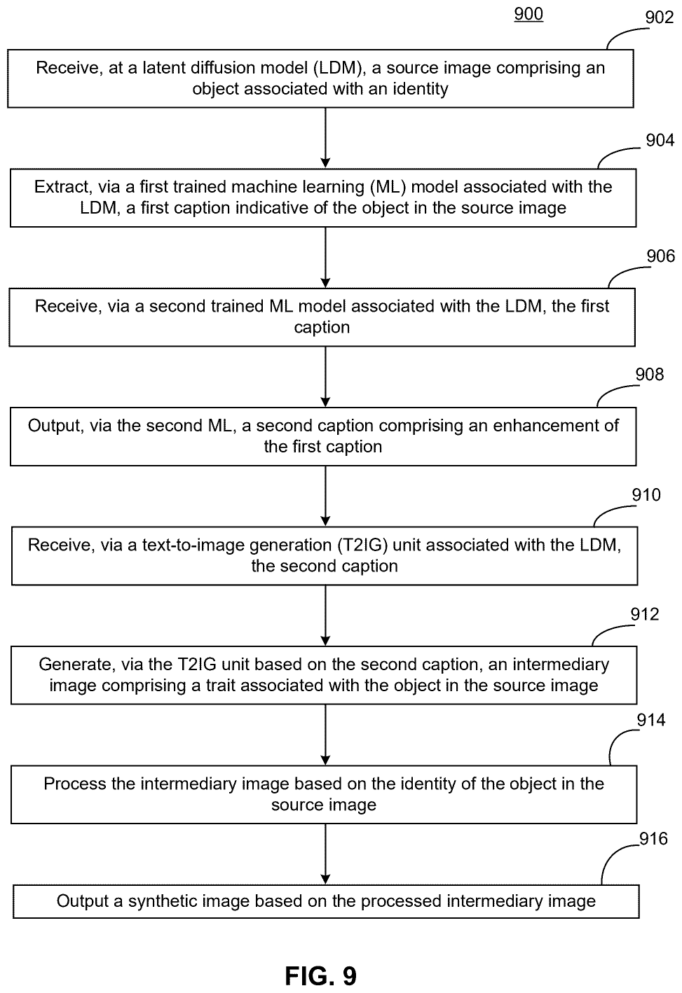

FIG. 4 illustrates a machine learning and training model, in accordance with an example of the present disclosure. The machine learning framework 400 associated with the machine learning model(s) 410 may be hosted remotely. Alternatively, the machine learning framework 400 may reside within a server 162 shown in FIG. 1, or be processed by an electronic device (e.g., head mounted displays, smartphones, tablets, smartwatches, or any electronic device, such as communication device 105, UE 30, etc.). The machine learning model(s) 410 may be communicatively coupled to the stored training data 420 in a memory or database (e.g., ROM, RAM) such as training database 422. In some examples, the machine learning model 410 (s) may be associated with operations of any one or more of the systems/architectures depicted in subsequent figures of the application. In some other examples, the machine learning model(s) 410 may be associated with other operations. For example, the machine learning model(s) 410 may be associated with the operations of FIG. 8 and the operations of FIG. 9. The machine learning model 410 may be implemented by one or more machine learning models(s) and/or another device (e.g., a server and/or a computing system (e.g., computing system 300)). In some embodiments, the machine learning model(s) 410 may be a student model trained by a teacher model, and the teacher model may be included in the training database 422.

### Personalization Model

According to an aspect of the subject technology described, novel approaches to improve fidelity and control in text-to-image synthesis are described in this application. Three facets relevant to eliciting a satisfying human visual experience may include identity preservation, prompt alignment, and visual appeal. To achieve all three facets, the exemplary architecture may employ a reference image including a subject with an identity guided by text prompts to generate a visually appealing, personalized target image in a diffusion model. The text prompts may include, for example, complex prompts to generate images with diversity. Diversity may include, but is not limited to, head and body poses, facial expressions and layout.

Generally, a diffusion model may be a type of generative AI model that progressively converts random noise into a structured output, such as an image or audio clip, through a series of learned steps. The architecture of a diffusion model may be centered around a deep neural network, which may use convolutional layers when dealing with images, or recurrent layers for sequence data like audio or text. The operation of the diffusion model may include two primary phases: the forward diffusion process and the reverse generative process. In the forward diffusion, the diffusion model may gradually add noise (e.g., Gaussian noise) to the data over a series of timesteps, transforming the original data into pure noise. This is done in a way that each step of adding noise is statistically tractable, allowing the diffusion model to learn how the data is being corrupted at each timestep.

Diffusion models may be generated based on the concept of knowledge distillation, where the goal is to transfer knowledge from a complex model (teacher) to a simpler model (student). Training a student diffusion model through the process of distillation begins with the generation or accessing of a well-trained, high-performance teacher model. The teacher model may have already learned how to effectively perform the task at hand, such as image generation, through a series of forward (e.g., adding noise) and reverse (e.g., removing noise) diffusion steps, as described above. In some embodiments, the teacher model may be a pre-trained model.

From a computation perspective, Text-to-Image (T2I) diffusion models gradually turn a noise e to a clear image x₀. While the diffusion process may happen in the pixel space [16, 20], a common practice is to have latent diffusion models (LDM) perform a diffusion process in a latent space z=ε(x₀). During training, the LDM models optimize the reconstruction loss in the latent space:

$${ℒ}_{diffusion} = {𝔼}_{z ∼ ε ( {x}_{0} ) , ϵ ∼ N ( 0 , 1 )} {‖ ϵ - {ϵ}_{θ} ( {z}_{t} ) , t ‖}_{2}^{2} \qquad ( 1 )$$

where [symbol] _{diffusion} is the diffusion loss. ϵ_{θ} represents the diffusion model. Zₜ is the noised input to the model (e.g., the LDM(s)) at timestep t.

Text or other condition signals C guide the diffusion process. Thus, the conditioned diffusion process generates images following the condition signals. Usually, the text condition is incorporated with the diffusion model through a cross-attention mechanism:

$$Attn ( Q , K , V ) = softmax ( \frac{{QK}^{T}}{\sqrt{d}} ) V \qquad ( 2 )$$

Where K=W_{K}C, V=W_{V}C represents transformations that map the condition C to the cross-attention key and values. Q=W_{Qϕ(xt)} represents the hidden state of the diffusion model.

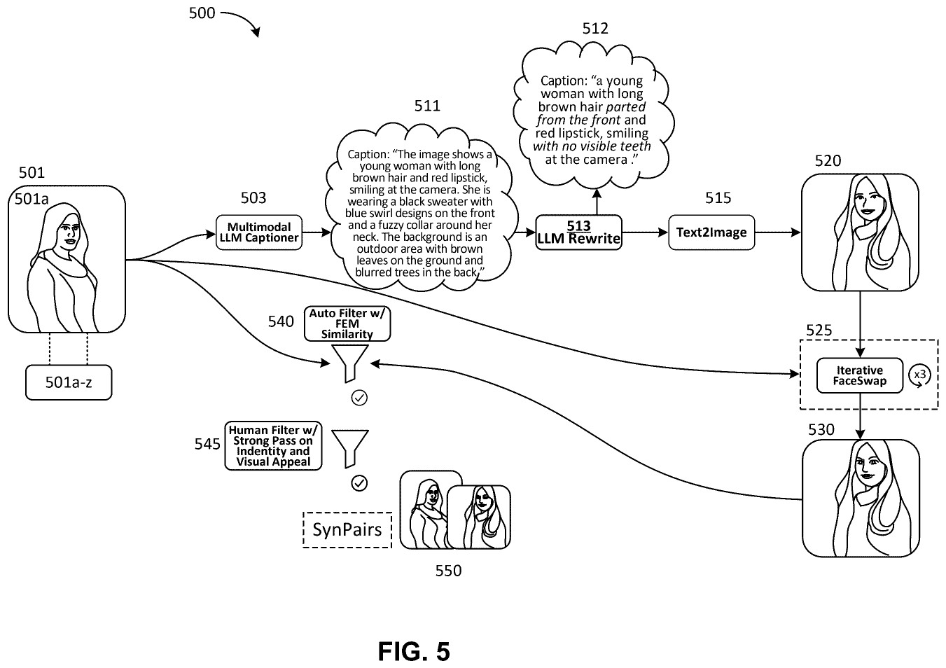

According to an exemplary aspect of the present disclosure, FIG. 5 illustrates an example system architecture 500 to generate a synthetic image. The synthetic paired data (e.g., SynPairs) includes a source image (e.g., real image) and a synthetically generated image. System 500 employs one or more ML models, such as for example a ML model (e.g., machine learning model 410) as depicted in FIG. 4, to curate large-scale, high-quality, paired data (same identity with varying expression, pose, and lighting conditions, etc.). As discussed further in this disclosure, it has been shown that curating paired data in a synthetic manner results in higher quality data being generated. In turn, creating a target image via a deployed, trained ML model may considerably be improved in comparison to sourcing only real images.

In an embodiment of the aspect as depicted in FIG. 5, a source image 501 is received at a first trained ML model 503 (e.g., a multimodal LLM captioner ML). In some embodiments, the source image 501 may contain a subject 501a with an identity distinct from other subjects. In other embodiments, the source image 501 may contain, or otherwise be associated with, plural subjects 501a-z of which one subject may be analyzed by the first trained ML model 503.

Next, the first trained ML model 503 analyzes the source image 501 to extract data. The first trained ML model 503 may include a Deep Learning Inference Framework (DLIF). The data may include a first caption 511 indicative of the subject 501a in the source image 501. In some examples, the data may include, or may be associated with, the extracted data (e.g., an extracted reference face of a user). In an example embodiment, for example, the first caption 511 in FIG. 5 indicates that the image shows “a young woman with long brown hair and red lipstick, smiling at the camera. She is wearing a black sweater with blue swirl designs on the front and a fuzzy collar around her neck. The background is an outdoor area with brown leaves on the ground and blurred trees in the back.” In a further embodiment, the first caption 511 may also include a modifier related to the subject 501a in the source image 501. The modifier may provide details about the subject's appearance or some type of action. For example, the modifier represented in italics may indicate, “a young woman with long brown hair and red lipstick, smiling at the camera while dunking a basketball in a hoop.”

Subsequently as illustrated in FIG. 5, the first caption 511 is received by a second trained ML model 513 (e.g., an LLM rewrite ML model). The second trained ML model 513 is configured to update the first caption 511 by injecting more gaze and pose diversity. In so doing, the second trained ML model 513 outputs a second caption. For example, the second caption (e.g., second caption 512) may enhance an attribute of the first caption 511 by including less noise or by presenting a different perspective. In some exemplary embodiments, the second caption may result in more diverse gaze and pose variations. This aids in creating a more accurate and refined description of the subject for the subsequent image generation process. For example, the second caption 512 with enhancements in italics may indicate, “a young woman with long brown hair parted from the front and red lipstick, smiling with no visible teeth at the camera.”

Next, the second caption, e.g., updated caption of the first caption 511, may be fed to a text-to-image generation (T2IG) unit 515. The T2IG unit 515 subsequently outputs a high-quality, intermediary synthetic image 520 indicative of, or associated with, the second caption. The intermediary synthetic image 520 may include a trait associated with the source image 501. For instance, the intermediary synthetic image 520 may have similar soft-biometric traits such as skin tone, hair, age, gender, or the like as the source image 501.

As further illustrated in FIG. 5, the intermediary synthetic image 520 is received by a face swap unit 525. The face swap unit 525 injects the identity of the subject 501a in the source image 501 into the received intermediary synthetic image 520. In some embodiments, this process may be iterated one or more times. In an example embodiment, the process is iterated three times. In so doing, it is envisaged that the final synthetic image 530 exhibits an improvement in identity preservation and image quality. That is, the outputted final synthetic image 530 may accurately represent the subject's identity and characteristics.

According to another embodiment as shown in FIG. 5, the final synthetic image 530 and the source image 501 are subsequently transmitted to, and received at, one or more filters 540, and 545. As depicted in FIG. 5, there are two filters. In some embodiments, this step occurs on a continuing basis. That is, plural final synthetic images and their associated source images (e.g., of the same subject or different subjects) are transmitted to one or more filters (e.g., filters 540, 545). Alternatively, filtering may occur in batch mode upon receiving plural final synthetic images and their associated source images.

The one or more real and synthetic images are run through the one or more filters 540, and 545 to assess arc face similarity, identity and/or visual appeal. In an embodiment, one of the filters may include a face embedding model (FEM). In some embodiments, a human in the loop (HITL) may be employed at a downstream filters, such as filter 545, to selectively assess and filter the synthetic and source image pairs.

The pass-through rates of the two filters may be customized. For example, the pass-through rate is determined based on one or more factors such as the identity or the visual appeal of the subject. The filter with a pass-through rate evaluates the pair consisting of the source image and the synthetic image based on factors such as identity or visual appeal of the subject. For example, the filters may permit only the top 10%, 5% or even 1% of the synthetic image and source image pairs to pass and ultimately be retained as training data 550 (e.g., SynPairs) for one or more other models. As referred to herein, a SynPair(s) may be a pair of two synthetic images of a same person.

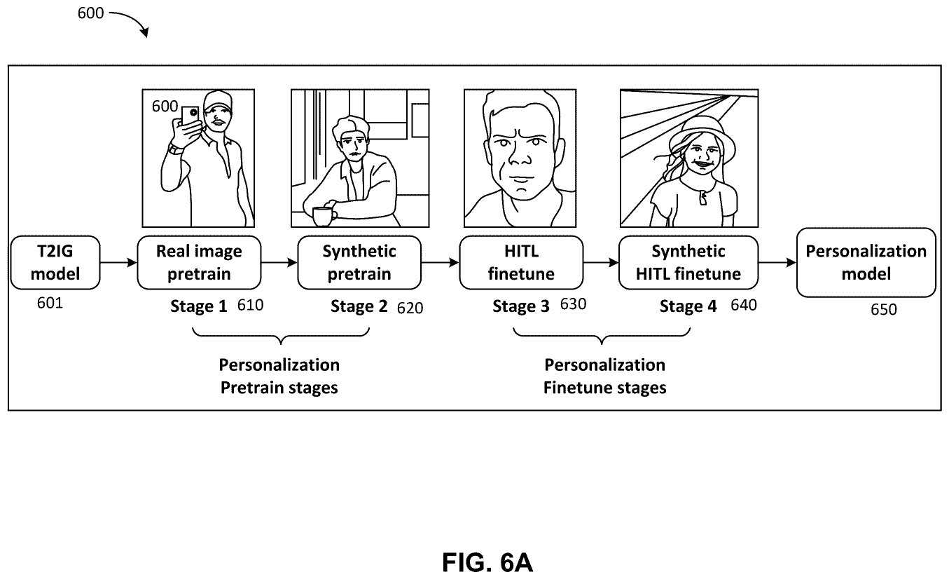

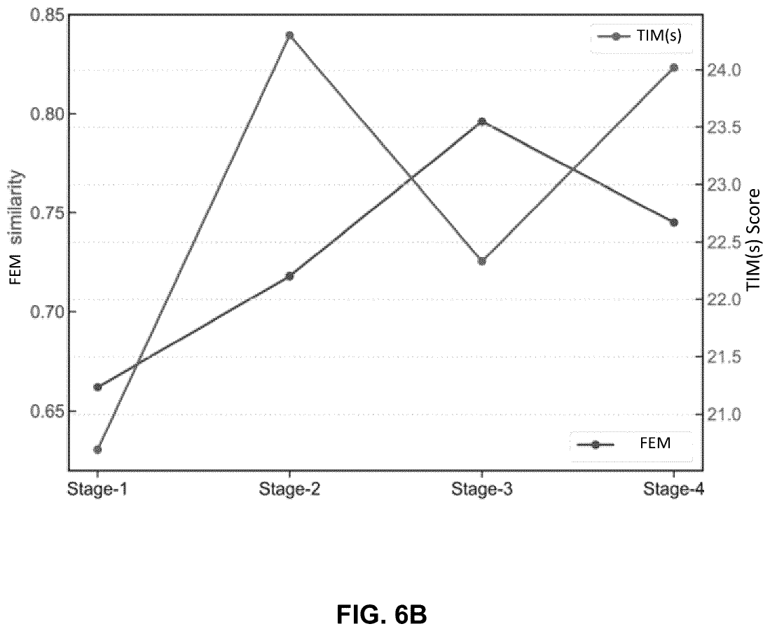

According to another aspect of the present disclosure, an architecture for refining a model's quality is described. According to an exemplary embodiment as depicted in FIG. 6A, the system architecture 600 may help enhance prompt alignment and identity preservation in a T2IG unit 601 via a multi-stage training process. This may be achieved in step-wise fashion by trading off between prompt alignment (e.g., editability) and identity preservation in view of a set of source (e.g., real) images and synthetic images ingested as training data (e.g., training data 420). As a result of the training process in step-wise fashion, the quality of the deployed ML model is improved. In some embodiments, the T2IG unit 601 may be the T2IG unit 515 depicted in system 500 in FIG. 5.

According to an embodiment as illustrated in FIG. 6A, the T2IG unit 601, such as for example the ML model(s) 410 in FIG. 4, may be trained in a multi-stage framework where a primary stage includes training data, such as for example training data 420 in FIG. 4, based upon real images and/or synthetic images. A second stage of the multi-stage framework may include training data (e.g., training data 420) of the other type being either source image training data or synthetic image training data. In other words, if the first stage includes only source images as training data, the second stage may only include synthetic images as training data. In embodiments employing more than two stages in the framework, each subsequent stage may follow the same order sequence as the first stage and the second stage. For instance, Stage 3 may include source images based upon source images in Stage 1, and Stage 4 may include synthetic images based upon Stage 2. In another embodiment for example, Stages 3 and 4 may include a HITL as depicted in FIG. 6A to assist with filtering data. In a further embodiment, it is envisaged that the real and synthetic data used in multi-stage finetuning may be based upon the source images and synthetic images generated by system 500.

In an embodiment of this aspect as depicted in FIG. 6A, Stage 1 610 and Stage 2 620 are defined as personalization pretrain stages. In these first two stages, defined as personalization pretrain stages, large scale person-oriented data with assorted image qualities may be employed. Meanwhile, Stage 3 630 and Stage 4 640, defined as personalization finetune stages, further finetune the personalization pretrain stages. Synthetic images are generated from their respective prompts resulting in high image-text alignment. This is due to synthetic data naturally exhibiting less noise. The tradeoff however is the identity information not being as rich as source image data.

In yet another embodiment of this aspect as shown in FIG. 6B, FEM similarity and text-image model(s) (TIM(s)) scores are graphically observed for the ML model (e.g., machine learning model(s) 410) after training at each of Stages 1, 2, 3 and 4. In some examples, the TIM(s) may, but need not, be an AI model or ML model that links text and images based on mapping the text and images into a shared embedding space. In this manner, the TIM(s) may understand and associate images and their corresponding textual descriptions (e.g., text-image pairs). As illustrated in the graph, upon training with source image pretraining data in Stage 1, FEM similarity is improved. Then, after training with synthetic pretraining data in Stage 2, prompt alignment is observed to be measurably higher, however identity preservation may not be ideal. After training with source image finetuning data in Stage 3, the identity meets a predetermined threshold (e.g., 0.80). Prompt alignment however drops from about 0.84 to about 0.73. After training with synthetic finetuning data in Stage 4, the FEM similarity modestly drops yet still meets a predetermined threshold. Additionally, prompt alignment significantly improves from about 22.4 to 24.0. As a result, the multi-stage finetuning process achieves an optimal trade-off between identity preservation and prompt alignment.

In a further embodiment, the obtained results after Stage 4 may be employed in another ML model for deployment. In an example, this may be a personalization model 650 as illustrated in FIG. 6A. In an embodiment, the personalization model 650 may be employed in a system, such as for example, system 500 to help generate high-quality SynPairs.

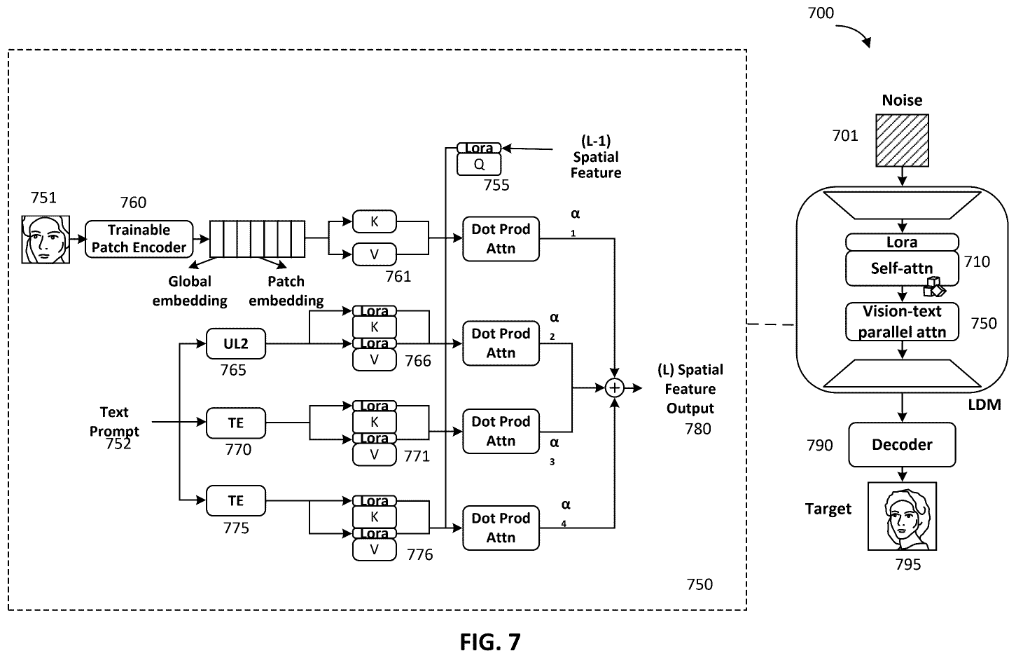

According to another aspect of the present disclosure, a system and method are described for generating a synthetic image via a LDM. This may be referred to as a personalization unit in some embodiments In an embodiment as depicted FIG. 7, a LDM 700 may be employed to process incoming noise via one more units ultimately to produce a target image 795. The LDM is responsible for the input reception. For instance, the LDM's role is to handle the initial input, ensuring that the reference image and text prompt are correctly received and processed for further analysis. The LDM may process a reference image 751 and a text prompt 752.

The LDM 700 may include a self-attention unit 710 and a vision-text parallel attention unit 750 (also referred to herein as vision-text parallel unit 750). In an embodiment as depicted in FIG. 7, low-rank adaptors, e.g., LoRA, may be employed on top of the self-attention unit 710 and the vision-text parallel unit 750. In this manner, the LoRA may be configured to partially fine-tune the self-attention to adapt a new personalization capability while preserving the LoRA's original generation capability. The self-attention unit 710 with a low-rank adaptor is arranged upstream of the vision-text parallel unit 750. This arrangement preprocesses the input before the input reaches the cross-attention units in the vision-text parallel attention unit 750 to help improve computational efficiency. In some examples, the input may be intermediate features from previous layers of a model (e.g., the LDM). The improvement to the computational efficiency may conserve computing resources (e.g., processor 32, co-processor 81, central processing unit 91) of a communication device (e.g., UE 30, computing system 300). Visual quality of the LDM 700 may also be preserved. The preservation of visual quality by the exemplary aspects of the present disclosure provides technical solutions to technical problems regarding improvements to image distortion. Additionally, convergence speed of the LDM 700 may be accelerated by up to five times based upon research studies conducted for the exemplary aspects of the present disclosure. Further, an output of the LDM is received by a decoder 790 to decode and deliver the target image 795.

According to an embodiment, a robust view of the vision-text parallel attention unit 750 is depicted within the dashed line box in FIG. 7. At a high level, a parallel attention architecture is employed to incorporate vision and text conditions. Specifically, vision conditions from a reference image and spatial features are fused via a vision cross-attention unit (e.g., vision-text parallel unit 750). The output of the vision cross-attention unit is summated with a text cross-attention output. In so doing, studies conducted in the instant aspects of the present disclosure indicate an improved balance of vision and text control.

As shown in FIG. 7, a reference image 751 is received by a trained vision encoder 760 which outputs a vision control signal. In some examples, the vision encoder 760 may be a text-to-image vision encoder. In some example aspects, the vision encoder 760 may be referred to as trainable patch encoder 760. As shown in FIG. 7, the vision control signal may include global embedding and patch embedding. The vision control signal is derived from a subject (e.g., an image of a person) present in the reference image 751. The vision control signal may also indicate an identity of the subject. The vision control signal provides relevant information about the subject's identity which may be used in subsequent steps to ensure that the generated target image 795 preserves the identity of the reference image 751.

The vision encoder 760 may communicate with a vision cross-attention unit 761. The vision control signal may be transmitted to the vision cross-attention unit 761, particularly to respective K and V components. The vision cross-attention unit 761 may be trained on multiple pairs of source images and synthetic images to enhance the ability of the vision cross-attention unit 761 to process and understand images. To further improve accuracy of the vision control signal extraction, the vision cross-attention unit 761 may facilitate cropping of the source image to focus on specific areas, such as the facial area of the subject or the background.

The text prompt 752 is received by one or more text encoders to extract a text control signal. Generally, the text encoders are responsible for generating a signal that is associated with the content of the text prompt and/or the reference image (e.g., reference image 751). As depicted in FIG. 7, the one or more text encoders may include a text encoder 765 (also referred to herein as Unified Language Learner (UL2) 765, and/or vision model 765), text encoder (TE) 770 (also referred to herein as large text encoder/decoder model 770), and/or a transformer model text encoder (TE) 775 (also referred to herein as TMTE 775). The selection of these encoders is driven by their respective strengths and suitability for specific tasks.

The text encoder 765, for instance, may share a common space with the vision encoder 760, e.g., a text-to-image vision encoder, to facilitate enhanced identity preservation. The text encoder 770 may be employed for its proficiency in comprehending long and intricate text prompts making it instrumental in handling complex input data.

The text encoder 775 may be integrated for its capability of encoding characters. The text encoder 775 may improve visual text generating in the image, e.g., text on a signage. This ensures that the vision control signal either maintains the subject's identity or understands the content of the text prompt.

Each of the text encoders 765, 770, 775 may be associated with a specific text cross-attention unit (e.g., text cross-attention units 766, 771, 776). The text control signals are transmitted to respective K and V components of each of the text cross-attention units 766, 771, 775. The K and V components of each text cross-attention unit may include a LoRA thereon. The LoRA is configured to partially fine-tune the cross-attention unit and/or associated components/weights (e.g., the K and V components which may also be weights) of the cross-attention unit. In so doing, improved efficiency and focus of the attention mechanism is observed within the text processing units.

Subsequently an output of the vision cross-attention unit is added to an output of the text cross-attention unit. Specifically, spatial features indicative of the reference image (e.g., reference image 751) and text prompt (e.g., text prompt 752) are generated via cross attention summation of the vision control signal and the text control signal(s). As illustrated in FIG. 7, each of α₁, α₂, α₃ and as representative of the vision signal(s) and text control signal(s) are added. As a result, a Spatial Feature Output 780 is derived/determined. Subsequently, the abstract spatial features are transformed into a concrete visual output via a decoder 790. As a result, a target image 795 is produced/generated.

In some embodiments, a hidden state of the diffusion model denoted as (L-1) Spatial Feature 755 is transmitted to each of the vision cross attention units and text cross attention units. The vision cross attention units and text cross attention units may have a LoRA thereon. In so doing, the output (e.g., a target image) more accurately relates to preserves the visual identity of the reference image 751.

According to a further embodiment, it is envisaged for the personalization model to be extended to multi-subject personalization. For example, in a two-person group photo, instead of passing the global embedding and patch embedding of the single reference image into the K and V components, vision embeddings from both reference images, e.g., of each of the persons, may be linked together in series and passed into the K and V components of the cross-attention units. As a result, an LDM 700 during training learns how to map from reference; to subject in a group photo while generating prompt-induced image context.

FIG. 8 illustrates an example flowchart illustrating operations for generating a target image from a reference image according to an example of the present disclosure. At operation 800, a device (e.g., computing system 300, UE 30) may receive, via a latent diffusion model (e.g., LDM 700), a reference image (e.g., reference image 751) and a text prompt (e.g., text prompt 752). At operation 802, a device (e.g., computing system 300) may extract, via a trained vision encoder (e.g., vision encoder 760) associated with the LDM, a vision control signal(s) based on an object in the reference image. The vision control signal(s) may indicate an identity of the object.

At operation 804, a device (e.g., computing system 300, UE 30) may extract, via one or more trained text encoders (e.g., text encoders 765, 770, 775) associated with the LDM, one or more text control signals associated with the text prompt. The text prompt may be associated with the reference image. At operation 806, a device (e.g., computing system 300, UE 30) may generate, via cross attention summation of (i) an output of one or more vision cross attention units (e.g., vision cross-attention unit 761) associated with the vision control signal(s) and (ii) an output of one or more text cross attention units (e.g., text cross-attention units 766, 771, 776) associated with the one or more text control signals, first spatial features (e.g., spatial feature output 780) indicative of the reference image and the text prompt. At operation 808, a device (e.g., computing system 300, UE 30) may output a target image (e.g., target image 795) based upon the generated first spatial features.

FIG. 9 illustrates an example flowchart illustrating operations of an exemplary method 900 to generate a target image from a reference image according to an example of the present disclosure. At operation 902, a device (e.g., computing system 300, UE 30) may receive, at a latent diffusion model (LDM), a source image (e.g., source image 501) comprising an object (e.g., subject 501a) associated with, or having, an identity. At operation 904, a device (e.g., computing system 300, UE 30) may extract, via a first trained machine learning (ML) model (e.g., first machine learning model 503) associated with the LDM, a first caption (e.g., caption 511) indicative of the object in the source image. At operation 906, a device (e.g., computing system 300, UE 30) may receive, via a second trained ML model (e.g., second machine learning model 513) associated with the LDM, the first caption.

At operation 908, a device (e.g., computing system 300, UE 30) may output, via the second ML, a second caption comprising an enhancement of the first caption. At operation 910, a device (e.g., computing system 300, UE 30) may receive, via a text-to-image generation unit (e.g., T2IG unit 515) associated with the LDM, the second caption. At operation 912, a device (e.g., computing system 300, UE 30) may generate, via the T2IG unit based on the second caption, an intermediary image (e.g., intermediary synthetic image 520) including a trait(s) associated with the object (e.g., subject 501a) in the source image (e.g., source image 501). In some examples, the trait(s) may include, but is not limited to, age, gender, skin, tone, or hair, and/or any combination thereof.

At operation 914, a device (e.g., computing system 300, UE 30) may process the intermediary image based on the identity of the object in the source image. In some examples, a face swap unit (e.g., face swap unit 525) of the device may process the intermediary image based on the identity of the object in the source image. At operation 916, a device (e.g., computing system 300, UE 30) may output a synthetic image (e.g., synthetic image 530) based on the processed intermediary image.

### Alternative Embodiments

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as components, without loss of generality. The described operations and their associated components may be embodied in software, firmware, hardware, or any combinations thereof.

Any of the steps, operations, or processes described herein may be performed or implemented with one or more hardware or software components, alone or in combination with other devices. In one embodiment, a software component is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer-readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer-readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed:

1. A method comprising:
receiving, via a latent diffusion model (LDM), a reference image and a text prompt associated with the reference image;
extracting, via a trained vision encoder in the LDM, a vision control signal from an object in the reference image that indicates an identity of the object;
extracting, via one or more trained text encoders associated with the LDM, one or more text control signals associated with the text prompt;
generating, via cross attention summation of (i) an output of one or more vision cross attention units associated with the vision control signal and (ii) an output of one or more text cross attention units associated with the one or more text control signals, first spatial features indicative of the reference image and the text prompt; and
outputting a target image based upon the generated first spatial features.

2. The method of claim 1, wherein the extraction of the vision control signal comprises cropping a facial area of the object or a background of the reference image.

3. The method of claim 1, wherein the one or more text cross attention units comprises a low rank adaptor to facilitate preprocessing of an input associated with the reference image or the text prompt.

4. The method of claim 1, wherein the target image preserves the identity of the object in the reference image.

5. The method of claim 1, further comprising:
receiving, via the one or more vision cross attention units and the one or more text cross attention units, second spatial features indicative of a hidden state of the LDM.

6. The method of claim 5, wherein the second spatial features comprise a low rank adaptor to facilitate preprocessing of input associated with the reference image or the text prompt.

7. The method of claim 1, wherein the trained vision encoder is trained on a plurality of pairs of a source image and a synthetically generated image.

8. The method of claim 1, wherein the trained vision encoder is trained in plural stages, wherein a first stage comprises a plurality of source images and a second stage comprises a plurality of synthetically generated images.

9. The method of claim 8, wherein the plural stages comprise a third stage and a fourth stage, wherein the third stage comprises a plurality of source images different than the source images in the first stage, and wherein the fourth stage comprises a plurality of synthetically generated images different than the synthetically generated images in the second stage.

10. The method of claim 1, wherein a self-attention unit comprising a low rank adaptor is arranged upstream of the one or more text cross attention units and the one or more vision cross attention units associated with the LDM.

11. A method comprising:
receiving, at a latent diffusion model (LDM), a source image comprising an object associated with an identity;
extracting, via a first trained machine learning (ML) model associated with the LDM, a first caption indicative of the object in the source image;
receiving, via a second trained ML model associated with the LDM, the first caption;
outputting, via the second ML, a second caption comprising an enhancement of the first caption;
receiving, via a text-to-image generation unit associated with the LDM, the second caption;
generating, via the text-to-image generation unit based on the second caption, an intermediary image comprising a trait associated with the object in the source image;
processing the intermediary image based on the identity of the object in the source image; and
outputting a synthetic image based on the processed intermediary image.

12. The method of claim 11, wherein the text-to-image generation unit comprises a deep learning inference framework.

13. The method of claim 11, wherein the source image comprises a real image.

14. The method of claim 11, wherein the first caption comprises an actionable modifier or an accessory of the object.

15. The method of claim 11, wherein the second caption comprises less noise than the first caption.

16. The method of claim 11, wherein the trait comprises any one or more of age, gender, skin tone or hair.

17. The method of claim 11, wherein the identity comprises a distinct characteristic of the object in relation to a plurality of other objects.

18. The method of claim 11, further comprising:
receiving, via a filter comprising a pass-through rate, a pair comprising the source image and the synthetic image, wherein the pass-through rate is based upon any one or more of the identity or a visual appeal of the object; and
determining whether the pair meets a predetermined threshold set for the pass-through rate.

19. An apparatus comprising:
one or more processors; and
at least one memory storing instructions, that when executed by the one or more processors, cause the apparatus to:
receive, via a latent diffusion model (LDM), a reference image and a text prompt associated with the reference image;
extract, via a trained vision encoder associated with the LDM, a vision control signal based on an object in the reference image that indicates an identity of the object;
extract, via one or more trained text encoders associated with the LDM, one or more text control signals associated with the text prompt;
generate, via cross attention summation of (i) an output of one or more vision cross attention units associated with the vision control signal and (ii) an output of one or more text cross attention units associated with the one or more text control signals, first spatial features indicative of the reference image and the text prompt; and
output a target image based upon the generated first spatial features.

20. The apparatus of claim 19, wherein when the one or more processors further execute the instructions, the apparatus is configured to:
perform the extract of the vision control signal by cropping a facial area of the object or a background of the reference image.
